(19) United States
(12) Patent Application Publication
(10) Pub. No.: US 2009/0324958 A1
(43) Pub. Date: Dec. 31, 2009

(54) Heat Setting Compounds Suitable for Sticking Together Coated Substrates

(75) Inventors: Jan Olaf Schulenburg, Zurich (CH); Urs Rheinegger, Zurich (CH); David Hofstetter, Winterthur (CH); Jürgen Finter, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/308,943

(22) PCT Filed: Jun. 29, 2007
(86) PCT No.: PCT/EP2007/056598

§ 371 Date: Dec. 30, 2008

(30) Foreign Application Priority Data
Jun. 30, 2006 (EP) 06116369.7

(51) Int. Cl. B32B 27/38; C08L 63/00; C08L 53/00; C08K 5/29; C08K 3/34; C08L 77/00; B29C 65/48

(52) U.S. Cl. 428/414; 524/612; 524/500; 524/505; 524/195; 524/442; 524/538; 156/60

(57) ABSTRACT

Described are heat hardening compounds which contain at least one epoxy resin, A, with on average more than one epoxy group per molecule, at least one impact-strength modifier, B, at least one crack promoter, C, as well as at least one hardener, D, for epoxy resin, which is activated by raised temperature. Silicate layers such as mica or talc and graphite are particularly suitable as crack promoters, C.

### BACKGROUND

1. Technical Field

The invention concerns the field of thermosetting epoxy-resin compositions with increased impact toughness.

2. Description of Related Art

In the manufacture of vehicles and building components or machinery and equipment, high-strength glues are being used more and more frequently instead of, or in combination with, conventional joining processes such as bolting, riveting, swaging, or welding. If building components are glued, the high strength and impact toughness of the glue are of the greatest importance.

Traditional epoxy glues admittedly exhibit high mechanical strength, and in particular, high tensile strength. During impact loading of the glued bond, however, traditional epoxy glues are usually very brittle and for that reason, under crash conditions, in which both tensile and monocoque stresses occur, they may not be sufficient by far for certain requirements, particularly those of the automobile industry. The strength at high, and particularly at low temperatures below −10° C., is often especially inadequate in this regard.

For that reason, various methods have been tried for improving the impact toughness of thermosetting epoxy glues.

EP-A-1 359 202 describes an improvement in impact toughness by using a urea derivative in a non-diffusing carrier, as well as impact-resistant compositions which contain this urea derivative and an epoxide adduct. EP-A-1 431 325 and EP-A-1 498 441 describe the use of epoxide-group-terminated impact-toughness-modifier polymers, as well as impact-resistant compositions that contain impact-toughness-modifier polymers. These compositions exhibit high impact toughness. However, they do display many kinds of problems in combination with coated substrates, in which, during impact stress, fractures result prematurely within this layer or, as the case may be, between the coating and the underlying substrate. However, coated substrates, in particular coated metal and alloys, are widely used in industrial processes, above all. In particular, galvanized metals and alloys are known for the fact that, due to their zinc coating, they are more difficult to glue to impact-resistant composite parts.

### SUMMARY

A goal herein is to produce thermosetting epoxy-resin compositions for joining, which, particularly in the structural gluing of coated substrates, display great improvement in the impact toughness of the bond.

It has now been unexpectedly found that a thermosetting composition as described herein is capable of achieving this and other goals. In particular, it has been found that fracture due to the impact of a sudden force occurs mainly in the area where these compositions join coating materials, particularly galvanized metals and alloys, and not within the coating layer or between the coating and the underlying substrate. Consequently, bonds with higher impact toughness are more readily achievable with such coated substrates than with traditional crash-resistant construction glues.

In embodiments, thermosetting epoxy-resin compositions are used as a single-component construction glue.

In embodiments, described are methods for gluing.

In embodiments, described is a glued article.

### DETAILED DESCRIPTION

In embodiments, described is a thermosetting composition which contains at least one epoxy resin A with an average of more than one epoxide group per molecule, at least one impact-toughness modifier B, at least one crack improver C, and at least one hardener D for epoxy resins, which is activated at increased temperature.

The thermosetting composition contains at least one epoxy resin A with an average of more than one epoxide group per molecule. The epoxide group is preferably a glycidyl ether group. In particular, the epoxy resin A is the glycidyl ether of a polyphenol, preferably, a diglycidyl ether of bisphenol-A or bisphenol-F, or its oligomers. Especially preferred as the epoxy resin A is a so-called liquid epoxy resin.

As used herein, the prefix “poly” in terms such as “polyphenol”, “polyisocyanate”, “polyol”, “polyurethane”, “polyether”, “polyglycidyl ester”, “polyester”, “polycarbonate”, or “polyamine” designates molecules which technically contain two or more of the respective functional groups.

Preferred diglycidyl ethers are those of formula (I).

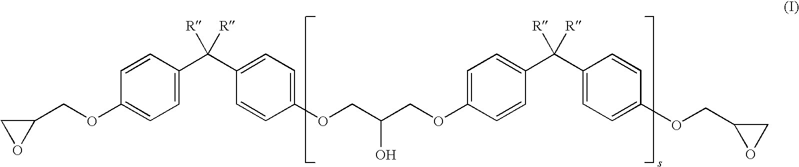

Here the substituents R″ stand for a hydrogen atom or a methyl group. In liquid resins, the degree of polymerization in formula (I) is typically between 0.05 and 0.20. Such liquid resins are commercially available. Commercially available products are, for example, Araldite® GY 250, Araldite® PY 304, Araldite® GY 282 (Huntsman) or D.E.R. 331 (Dow) or Epikote 828 (Resolution).

In the manufacturing processes for these resins, it is clearly stipulated that higher-molecular-weight constituents are also included in the liquid resins.

Furthermore, it is also possible that, in addition to such a liquid resin, a higher-molecular-weight solid epoxy resin with formula (I) is available with a degree of polymerization typically between 2 and 12. It is understood that a molecular-weight distribution is always present. Such solid epoxy resins are commercially available, for instance, from Dow or Huntsman or Resolution.

The epoxy resin A with an average of more than one epoxide group per molecule is present in an amount of 20-55% wt., preferably 25-35% wt., in the thermosetting composition.

The thermosetting compound contains at least one impact-toughness modifier B. “Impact-toughness modifiers” are organic compounds that improve the impact strength of the composition. A composition containing an impact-toughness modifier is therefore less damaged by the effect of an impact-like force than the corresponding composition without an impact-toughness modifier.

Impact-toughness modifiers are known in the art. A preferred impact-toughness modifier B is selected from the group consisting of
core-shell copolymers,
block copolymers, which arise from the polymerization of at least two unsaturated monomers,
urea derivatives in a carrier, and
rubbers, such as liquid rubbers, preferably reactive liquid rubbers.

Core-shell polymers consist of an elastic core polymer and a rigid shell polymer. Particularly suitable core-shell polymers consist of a core made of a cross-linked elastic acrylate or butadiene polymer, which is grafted onto a rigid shell of a rigid thermoplastic polymer.

Preferred core-shell polymers are the so-called MBS polymers, which are commercially available under the trade name of Clearstrength™ from Atofina or Paraloid™ from Rohm and Haas.

Block copolymers are produced by radical or anionic polymerization.

Particularly suitable for block copolymers are those monomers exhibiting one olefinic unsaturated double bond, which are formed from an anionic or controlled radical polymerization of methacrylic acid ester, with at least one additional monomer. Monomers exhibiting an olefinic, unsaturated double bond are, in particular, those in which the double bond is immediately conjugated with one heteroatom or with at least one other double bond. Particularly suitable are monomers which are selected from the group including styrene, butadiene, acrylonitrile, and vinyl acetate. Such block copolymers are, in particular, those block copolymers of methacrylic acid methylester, styrene, and butadiene. Such block copolymers are available, for example, as tri-block copolymers under the group designation of SBM from Arkema.

Specifically suitable block copolymers are styrene block copolymers, that is, those copolymers that are produced from styrene as a monomer from at least one other alkene or conjugated dialkene. This additional alkene or conjugated dialkene is preferably butadiene, isoprene, ethylene, or propylene, most preferably butadiene or isoprene. Such especially preferred block copolymers are block copolymers that exhibit a styrene/butadiene/styrene (SBS) and/or a styrene/isoprene/styrene (SIS) and/or a styrene/ethylene/butylene/styrene (SEBS) and/or a styrene/ethylene/propylene/styrene (SEPS) block and/or a styrene/butadiene/styrene (SBS) block, preferably a styrene/buta-diene/styrene (SBS) and/or a styrene/isoprene/styrene (SIS) block. Such block copolymers are commercially available from Kraton Polymers under the trade name of Kraton®, for example from the Kraton® D and Kratong G product lines, and preferably from the Kraton® D product line.

Suitable urea derivates in a carrier are, in particular, reaction products of an aromatic monomeric diisocyanate with an aliphatic amine compound. It is also entirely possible to use several different monomeric diisocyanates to react with one or several aliphatic amine compounds, or to react one monomeric diisocyanate with several aliphatic amine compounds. The reaction product of 4-4′-diphenyl-methyl-diisocyanate (MDI) with butylamine has proven to be particularly advantageous.

The urea derivative is present in a carrier. The carrier may be a plasticizer, preferably a phthalate or an adipate, particularly preferably a diisodecyl phthalate (DIDP) or dioctyl adipate (DOA). The carrier may also be a non-diffusing carrier. This is preferred to ensure, insofar as possible, a low migration of unregulated constituents after thermosetting. Blocked polyurethane pre-polymers are preferred as a non-diffusing carrier.

The manufacture of such preferred urea derivatives and carriers is described in detail in the patent application EP 1 152 019 A1, which is herein incorporated by reference. A preferred carrier is a blocked polyurethane pre-polymer, particularly one arising due to reaction of a tri-functional polyether polyol with IPDI and subsequent blocking of the terminal isocyanate group with caprolactam.

In addition to natural rubbers, synthetic rubbers are also particularly suitable. Liquid rubbers are especially suitable rubbers. Preferred rubbers are reactive liquid rubbers. Such reactive liquid rubbers exhibit reactive groups. Reactive liquid rubbers with epoxy groups, particularly those with glycidyl ether groups, are especially preferred.

Examples of suitable liquid rubbers are carboxyl-group- or epoxy-group-terminated butadiene/acrylonitrile copolymers, such as those offered commercially in the product series of Hycar® CTB, Hycar® CTBN, Hycar® CTBNX, or Hycar® ETBN from B.F. Goodrich®, designated Noveon. Preferred adducts of amine-group-terminated butadiene/acrylo-nitrile copolymers may also be used with polyglycidyl ethers, such as those offered commercially in the product series of Hycar® ATB and Hycar® ATBN from B.F. Goodrich® or Noveon.

Further examples of suitable liquid rubbers are phenol-terminated pre-polymers such as, for instance, those described in EP-A-0 338 995, particularly those from page 13, line 25 to page 15, or in WO 2005/007766, particularly those from page 17, line 25 to page 18.

Further examples of reactive liquid rubbers are pre-polymers exhibiting phenol, amino, isocyanate, or epoxy end-groups, such as, for instance, those described in EP-A-0 353 190, particularly on page 9, line 40 to page 10.

In one embodiment, the reactive liquid rubbers are elastomer-modified pre-polymers exhibiting epoxy groups, such as those marketed commercially as the product line of Polydis®, particularly the product line of Polydis® 36, from the firm of Struktol® (Schill+Seilacher Group, Germany) or as the product line of Albipox (Hanse Chemie, Germany).

Preferred reactive liquid rubbers with epoxy groups are those of formula (II).

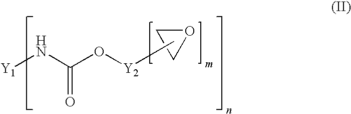

Here Y₁ represents an n-valent remnant of an isocyanate-group-terminated, linear or branched polyurethane pre-polymer PU1, after the removal of the terminal isocyanate groups. Y₂ represents a remnant of an aliphatic, cycloaliphatic, aromatic, or araliphatic epoxide containing a primary or secondary hydroxyl group after the removal of the hydroxide and epoxide groups. In addition, the indices m and n represent the values 1, 2, or 3 and the values 2 to 8, respectively.

Polymers of formula (II) may be derived from, for instance, the reaction of a monohydroxyl-epoxide compound of formula (III) with a linear or branched polyurethane pre-polymer PU1, terminated with an isocyanate group, of formula (IV):

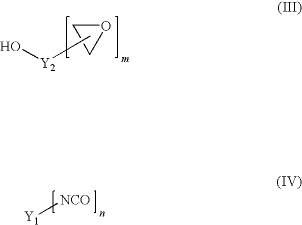

Polyurethane pre-polymer PU1 is in turn derived from at least one diisocyanate or triisocyanate as well as from a polymer Q_{PM} with terminal amino, thiol, or hydroxyl groups and/or from a substituted or unsubstituted polyphenol Q_{PP}.

Suitable diisocyanates are aliphatic, cycloaliphatic, aromatic, or araliphatic diisocyanates, especially methylene diphenyl diisocyanate (MDI), hexamethylene diisocyanate (HDI), toluene diisocyanate (TDI), tolidine diisocyanate (TODI), isophorone diisocyanate (IPDI), trimethyl hexamethylene diisocyanate (TMDI); 2,5- or 2,6-bis-(isocyanatomethyl)-bicyclo[2.2.1]heptane; 1,5-napthalene di-isocyanate (NDI), dicyclohexylmethyl diisocyanate (H₁₂MDI), p-phenylene diisocyanate (PPDI), m-tetramethylxylylene diisocyanate (TMXDI), etc., and their dimers. HDI, IPDI, MDI, or TDI are preferred.

Suitable triisocyanates are trimers or biurates of aliphatic, cycloaliphatic, aromatic, or araliphatic diiso-cyanates, particularly the isocyanates and biurates of the diisocyanates described in the preceding paragraph.

Preferred polymers Q_{PM} are those with terminal amino, thiol, or hydroxyl groups. Polymers Q_{PM} with two or three terminal amino, thiol, or hydroxyl groups are particularly preferred.

Polymers Q_{PM} advantageously exhibit an equivalent weight of 600-6000, preferably 600-4000, particularly preferably 700-2200 g/equivalent of NCO-reactive groups.

Polymer Q_{PM} may be one or more polyols such as the following polyols or any desired blends thereof:
polyoxyalkylene polyols, also called polyether polyols, which are the polymerization product of ethylene oxide; 1,2-propylene oxide; 1,2- or 2,3-butylene oxide; tetrahydrofuran, or blends thereof, polymerized if necessary with the aid of a starter molecule with two or three active H atoms, such as, for instance, water or compounds with two or three OH groups;
polyoxyalkylene polyols can be used, which exhibit a lower degree of unsaturation (measured according to ASTM D-2849-69 and given in milliequivalents of unsaturation per gram of polyol (mEq/g), produced, for example, with the aid of a so-called double-metal cyanide-complex catalyst (DMC catalyst, for short), as well as polyoxyalkylene polyols with a higher degree of unsaturation, produced, for instance, with the aid of anionic catalysts such as NaOH, KOH, or alkali alcoholates;
polyoxypropylene diols and triols with a degree of unsaturation less than 0.02 mEq/g and with a molecular weight in the range of 1000-30,000 daltons, polyoxybutylene diols and triols, polyoxypropylene diols and triols with a molecular weight of 400-8000 daltons, and the so-called “EO-end-capped” (ethylene-oxide-end-capped) polyoxypropylene diols or triols. The latter are specific polyoxypropylene polyoxyethylene polyols, which are obtained, for example, by the alcoxylation of pure polyoxypropylene polyols after the conclusion of polypropoxylation with ethylene oxide and which thereby exhibit primary hydroxy groups.
polyhydroxy-terminated polybutadiene polyols such as, for example, those produced by polymerization of 1,3-butadiene and allyl alcohols, and their hydration products;
grafted styrene acrylonitrile polyether polyols, which are, for example, supplied by Elastogran under the name of Lupranol®;
polyhydroxy-terminated acrylonitrile/polybutadiene copolymers such as, for example, those which can be produced from carboxyl-terminated acrylonitrile/polybutadiene co-polymers (commercially available under the name of Hycar® CTBN from B.F. Goodrich® or Noveon) and epoxides or produced from amino alcohols;
polyester polyols produced, for example, from di- or trivalent alcohols such as, for instance, 1,2-ethanediol, diethylene glycol; 1,2-propanediol; dipropylene glycol; 1,4-butanediol; 1,5-pentanediol; 1,6-hexanediol; neopentyl glycol, glycerine; 1,1,1-trimethylolpropane, or blends of the afore-mentioned alcohols with organic carboxylic acids or their anhydrides or esters, such as, for example, succinic acid, glutaric acid, adipic acid, suberic acid, sebacic acid, dodecanedicarboxylic acid, maleinic acid, fumaric acid, phthalic acid, isophthalic acid, terephthalic acid, and hexahydrophthalic acid, or mixtures of the afore-mentioned acids, as well as the polyester polyols from lactones such as, for instance, ε-caprolactone;
polycarbonate polyols such as are obtainable by the reaction, for example, of those alcohols mentioned above with dialkyl carbonates, diaryl carbonates, or phosgene, for use in forming polyester polyols.

Preferred are polymers Q_{PM} of di- or higher-functional polyols are advantageous with OH equivalent weights of 600 to 6000 g/OH-equivalent, in particular of 600 to 4000 g/OH-equivalent, preferably 700-2200 g/OH-equivalent. In addition, the polyols are advantageously selected from the group consisting of polyethylene glycols, polypropylene glycols, polyethylene glycol/polypropylene glycol/block copolymers, polybutyl-ene glycols, hydroxyl-terminated polybutadienes, hydroxyl-terminated polybutadiene co-acrylonitriles, synthetic hydroxyl-terminated rubbers, and the hydration products thereof and mixtures thereof.

Additional preferred polymers Q_{PM}, are di- or higher-functional amino-terminated polyethylene ether, polypropylene ether, polybutylene ether, polybutadiene, polybutadiene/acrylonitrile, such as, for example, those marketed under the name of Hycar® CTBN from Hanse Chemie AG, Germany, further amino-terminated synthetic rubbers, and mixtures thereof.

For certain applications, particularly suitable as polymers Q_{PM} are polybutadienes which exhibit hydroxyl groups or polyisoprenes or their hydrated reaction products.

It is furthermore possible that the polymers Q_{PM} can also be chain-elongated, such as can be carried out in a manner known in the art by means of the reaction of polyamines, polyols, and polyisocyanates, particularly of diamines, diols, and diisocyanates.

The following illustrates the formation of a diisocyanate and a diol formed according to this method, wherein, depending on a more refined stoichiometry, a species of formula (V) or (VI) are as follows:

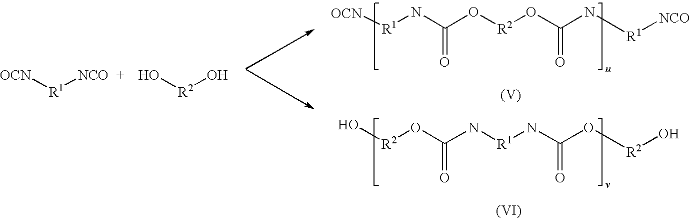

wherein R¹ and R² represent divalent organic remnants, and the indices vary, depending on the stoichiometric ratio, from 1 to typically 5.

The species of formula (V) or (VI) can then be made to further react again. Thus, for example, from the species of formula (V) and a diol with a divalent organic remnant R³, a chain-elongated polyurethane pre-polymer PU1 can be formed, with the following formula:

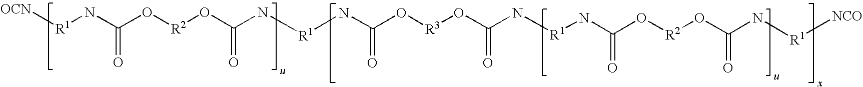

The indices x and y vary, depending on the stoichiometric ratio, from 1 to 5, particularly being 1 or 2.

From the species of formula (VI) and a diisocyanate with a divalent organic remnant R⁴, a chain-elongated poly-urethane pre-polymer PU1 with the following formula can be formed:

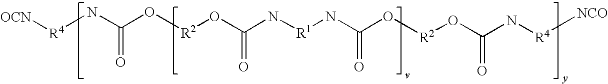

In addition, the species of formula (V) can also react with the species of formula (VI), so that a chain-elongated polyurethane pre-polymer exhibiting an NCO group arises.

For chain elongation, diols and/or diamines and diisocyanates are especially preferred. It is known in the art that higher-functional polyols, such as, for example trimethylolpropane or pentaerythrite, or higher-functional polyisocyanates, such as isocyanurates of diisocyanates, can also be used for chain elongation.

In polyurethane pre-polymers PU1 generally and in chain-elongated polyurethane pre-polymers specifically, it is advantageous to ensure that the pre-polymers do not exhibit too high a viscosity, particularly if higher-functional compounds are used for chain elongation, because this can make their reaction with polymers of formula B more difficult.

As polymers Q_{PM}, polyols are preferred with a molecular weight between 600 and 6000 daltons, selected from the group consisting of polyethylene glycols, polypropylene glycols, polyethylene glycol-polypropylene glycol-block polymers, polybutylene glycols, hydroxyl-terminated polybutadienes, hydroxyl-terminated polybutadiene-acrylonitrile copolymers, and their mixtures.

As polymers Q_{PM}, particularly preferred are α,ω-polyalkylene glycols with C₂-C₆-alkylene groups or with mixed C₂-C₆-alkylene groups, which are terminated with amino, thiol, or, preferably, hydroxyl groups. Especially preferred are polypropylene glycols or polybutylene glycols. In addition, hydroxyl-group-terminated polyoxybutylenes are especially preferred.

As a polyphenol Q_{PP}, bis-, tris-, and tetraphenols are particularly suitable. These are understood to be either pure phenols or substituted phenols. The type of substitution can be very diverse. In particular, understood here is a substitution directly to an aromatic core, to which the phenolic OH group is bound. Phenols are, in addition, either single-core aromatics or multi-core or condensed aromatics or heteroaromatics, which exhibit the phenolic OH-groups directly on the aromatics or, to be precise, on the hetero-aromatics.

Among other things, the required reaction with isocyanates is affected by the type and position of such a substitution in the formation of the polyurethane pre-polymer PU1.

Especially suitable are the bis- and trisphenols. Suitable as bisphenols or trisphenols, for example, are 1,4-dihydroxybenzene; 1,3-dihydroxybenzene; 1,2-dihydroxybenzene; 1,3-dihydroxytoluene; 3,5-dihydroxybenzoate; 2,2-bis(4-hydroxyphenyl)propane (=bisphenol-A), bis(4-hydroxyphenyl)-methane (=bisphenol-F); bis(4-hydroxyphenyl)sulfone (=bisphenol-S); naphtoresorcinol, dihydroxynaphthalene, dihydroxyanthraquinone, dihydroxy-biphenyl; 3,3-bis(p-hydroxyphenyl)phthalide; 5,5-bis(4-hydroxyphenyl)hexahydro-4,7-methanoindane; phenolphthalein, fluorescein; 4,4′-[bis-(hydroxyphenyl)-1,3-phenylene-bis-(1-methylethylidene)] (=bisphenol-M); 4,4′-[bis-(hydrozyphenyl)-1,4-phenylene-bis-(1-methylethylidene)] (=bisphenol-P); o,o-diallyl-bisphenol-A, diphenols, and dicresols produced by the reaction of phenols or cresols with diisopropylidene benzenol, phloroglucin, gallic acid ester, phenol or cresol novolacs with —OH functionality of 2.0 to 3.5, as well as all isomers of the aforesaid compounds.

Preferred diphenols and dicresols produced by the reaction of phenols or cresols with diisopropylidene benzenol exhibit a structural chemical formula like that corresponding to cresol; for example:

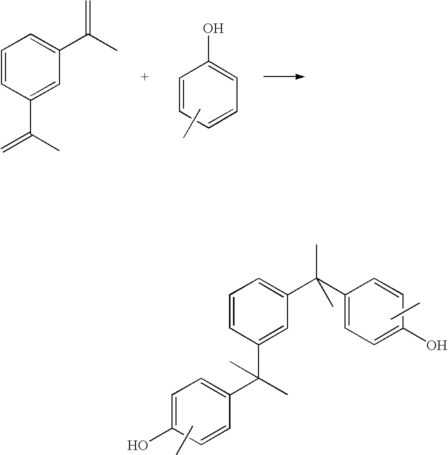

Especially preferred are highly volatile bisphenols. Most preferable are bisphenol-M and bisphenol-S.

The preferred Q_{PP} exhibits two or three phenolic groups.

In a first embodiment, the polyurethane pre-polymer PU1 is produced from at least one diisocyanate or triisocyanate and from a polymer Q_{PM} with terminal amino, thiol, or hydroxyl groups. The production of the polyurethane pre-polymer PU1 takes place in a manner known in the art, particularly, in a manner wherein the diisocyanate or triisocyanate is introduced in stoichiometric excess relative to the amino, thiol, or hydroxyl groups of the polymer Q_{PM}.

In a second embodiment, the polyurethane pre-polymer PU1 is produced from at least one diisocyanate or triisocyanate and from one substituted or unsubstituted polyphenol Q_{PP}. The production of the polyurethane pre-polymer PU1 occurs in a manner known in the art, in particular in a manner wherein the diisocyanate or triisocyanate is introduced in stoichiometric excess relative to the phenolic groups of the polyphenol Q_{PP}.

In a third embodiment, the polyurethane pre-polymer PU1 is produced from at least one diisocyanate or triisocyanate and from one polymer Q_{PM} with terminal amino, thiol, or hydroxyl groups, as well as from one substituted or unsubstituted polyphenol Q_{PP}. For production of the polyurethane pre-polymer PU1 from at least one diisocyanate or triisocyanate and from one polymer Q_{PM} with terminal amino, thiol, or hydroxyl groups, as well as from one substituted or unsubstituted polyphenol Q_{PP}, various possibilities exist for bonding.

In a first process, called a “composite process”, a blend of at least one polyphenol Q_{PP} and at least one polymer Q_{PM} is reacted with at least one diisocyanate or triisocyanate in an excess of isocyanate.

In a second process, called “2-step process I”, at least one polyphenol Q_{PP} is reacted with at least one diisocyanate or triisocyanate in an excess of isocyanate, and subsequently reacted with at least one polymer Q_{PM} in excess.

Finally, in a third process, called “2-step process II”, at least one polymer Q_{PM} is reacted with at least one diisocyanate or triisocyanate in an excess of isocyanate, and subsequently reacted with at least one polyphenol Q_{PP} in excess.

The three processes lead to isocyanate-terminated polyurethane pre-polymers PU1, which, with an identical composition, can differ in the sequence of their structural elements. All three processes are suitable; however, the “2-step process II” is preferred.

If the isocyanate-terminated polyurethane pre-polymers PU1 described are formed of difunctional components, it is shown that the equivalence ratio of polymer Q_{PM} to polyphenol Q_{PP} is preferably greater than 1.50, and the equivalence ratio of polyisocyanate/(polyphenol Q_{PP}+polymer Q_{PM}) is preferably greater than 1.20.

If the average functionality of the components used is greater than 2, then a more rapid increase in molecular weight occurs than in the purely difunctional case. It is known in the art that the limits for possible equivalence ratios are strongly dependent on whether either the selected polymer Q_{PM}, polyphenol Q_{PP}, diisocyanate, or triisocyanate or any of several of the components mentioned has a functionality of greater than 2. Depending on this, different equivalence ratios can be adjusted, the limits of which are defined by the viscosity of the resultant polymers and which have to be experimentally determined case by case.

The polyurethane pre-polymer PU1 preferably exhibits an elastic character and demonstrates a glass transformation temperature Tg lower than 0° C.

The monohydroxyl-epoxide compound of formula (II) exhibits one, two, or three epoxide groups. The hydroxyl groups of this monohydroxyl-epoxide compound (III) can represent a primary or a secondary hydroxyl group.

Such monohydroxyl-epoxide compounds are produced, for instance, by reacting polyols with epichlorohydrin. Depending on the progress of the reaction, the corresponding monohydroxyl-epoxide compounds also occur in different concentrations in the reaction of multifunctional alcohols, with epichlorohydrin as a by-product. These are isolated by separation operations known in the art. As a rule, it is sufficient to introduce, in the glycidylization reaction of polyols obtained, a product mix of polyols completely and partially reacted with glycidyl ether. Examples of such hydroxyl-bearing epoxides are trimethylolpropane diglycidylether (as a mixture included in trimethylol-propane triglycidylether), glycerine diglycidyl ether (as a mixture contained in glycerine triglycidylether), and pentaerythrite triglycidylether (as a mixture contained in pentaerythrite tetraglycidylether). Preferably trimethylol-propane diglycidylether is used, which occurs in relatively high proportion in the trimethylolpropane triglycidylether usually produced.

Alternately, other similar hydroxyl-bearing epoxides can be used, in particular glycidol, 3-glycidyl oxybenzyl alcohol, or hydroxymethyl-cyclohexene oxide. In addition, the β-hydroxyether of formula (VII) is preferred, which is produced in standard liquid epoxy resins from bisphenol-A (R═CH₃) and contains up to approximately 15% epichlorohydrin, as well as the corresponding β-hydroxyethers of formula (VII), which are formed in the reaction of bisphenol-F (R═H) or a mixture of bisphenol-A and bisphenol-F with epichlorohydrin.

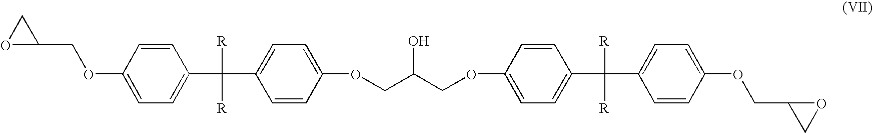

In addition, different epoxides having one β-hydroxyether group can also be used, produced by the reaction of (poly)epoxides with a deficiency of univalent nucleophiles such as carboxylic acid, phenols, thiols, or secondary amines.

The free primary or secondary OH functionality of the monohydroxyl-epoxide compound of formula (III) permits a efficient reaction with terminal isocyanate groups of pre-polymers, without having to introduce for this a non-ratio-related excess of epoxide components.

For the reaction of the polyurethane pre-polymers PU1 of formula (IV), Stoichiometric amounts of a monohydroxyl-epoxide compound of formula (III) or their blends can be introduced. The OH groups or isocyanate groups can deviate from the stoichiometry relative to these equivalents. The ratio [OH]/[NCO] is 0.6 to 3.0, preferably 0.9 to 1.5, and particularly preferably 0.98 to 1.1.

An impact-toughness modifier B of formula (II) is preferred.

The impact-toughness modifier B comprises from 5-45% wt., preferably 20-35% wt. of the thermosetting composition.

In addition, the thermosetting composition contains at least one crack improver C.

A crack improver is understood in the present document to be a solid at room temperature. Due to its own cohesive strength, which is less than the cohesive strength of the epoxy resin A hardened with hardener D, crack improver C is capable of reducing the cohesive strength of the hardened composition from a limiting concentration of the crack improver in the composition. Below this limiting concentration, this substance acts as a filler.

The limiting concentration is dependent on the substance considered as the crack improver. Typically, the limiting concentration of this substance is 0.25% wt. or more, relative to the total composition. Various solid substances are suitable as crack improvers C, such as, for example, solid polymers such as polyethylene flakes or fibers.

In a first, preferred embodiment, the crack improver C is a phyllosilicate. Phyllosilicates exhibit layers made up of SiO₄ tetrahedra, in which each SiO₄ tetrahedron is bound at three corners to three neighboring SiO₄ tetrahedra. Cations lie in between these layers. There may be two, three, or four different layers. Due to this laminar and sheet structure, phyllosilicates split easily along these layers.

Particularly preferred as phyllosilicates are talc, the phyllosilicates in the mica group, and those in the chlorite group. These are, in particular, mica, talc, illite, kaolinite, montmorillonite, muscovite, and biotite.

In a second, preferred embodiment, the crack improver C is graphite. Graphite is a carbon modification. Graphite exhibits a laminar structure. Since the individual laminae are not covalently bound to one another, individual layers are readily displaced or separated.

In a third, preferred embodiment, the crack improver C is a polyamine or polyaminoamide which is solid at room temperature, and preferably exhibits a softening point above 100° C., preferably between 100° C. and 120° C. Especially suitable are polyaminoamides of a type such as are marketed by Huntsman under the trade name of Aradur HT 939 EN(CAS No. 68003-28-1). It is essential that the crack improver be solid at room temperature. Liquid polyamines or polyaminoamides result in no reduction in cohesive strength of the thermosetting composition.

Preferred as the crack improver C is graphite or a phyllosilicate, particularly graphite, mica or talc. Talc is most preferred as the crack improver C.

It is also preferred that the crack improver C exhibit a laminar structure. Only small forces operate between these laminae, and, as a result, they split along these layers without great expenditure of force.

The crack improver C comprises 0.25-25% wt., preferably 1-25% wt., and particularly preferably 2-15% wt., of the thermosetting composition. In the event that a phyllosilicate is the crack improver C, it is preferred that it comprise 6 to 25% wt., preferably 8-25% wt., of the thermosetting composition. If graphite is the crack improver C, it is preferred that it comprise 8-25% wt., preferably 1-5% wt., of the thermosetting composition.

In addition, the thermosetting composition contains at least one hardener D for epoxy resins, which is activated at increased temperature. The hardener is preferably selected from the group consisting of dicyandiamide, guanamine, guanidine, aminoguanidine, and their derivatives. In addition, catalytically effective substituted ureas may be used such as 3-chloro-4-methylphenylurea (Chlortoluron) or phenyl-dimethylurea, particularly p-chlorophenyl-N,N-dimethylurea (Monuron), 3-phenyl-1,1-dimethylurea (Fenuron) or 3,4-dichlorophenyl-N,N-dimethylurea (Duron); compounds of the imidazole class; and amine complexes. Dicyandiamide is especially preferred.

The hardener D comprises 1-10% wt., preferably 2-6% wt. of the thermosetting compound.

The composition may contain additional components. Such components include, in particular, epoxide-group-bearing reactive diluents, catalysts, heat and light stabilizers, thixotropic agents, plasticizers, solvents, colorants, and pigments, as well as fillers.

In a further, preferred embodiment, the composition contains, in addition, at least one epoxide-group-bearing reactive diluent. Among these reactive diluents are:
glycidyl ethers of monofunctional, saturated or unsaturated, branched or unbranched, cyclic or open-chain C₄-C₃₀ alcohols, for example, butanolglycidyl ether, hexanolglycidyl ether, 2-ethylhexanol ether, allylglycidyl ether, tetrahydrofurfuryl- and furfuryl-glycidyl ethers, trimethoxy silylglycidyl ether, etc.
glycidyl ethers of difunctional, saturated and unsaturated, branched or unbranched, cyclic or open-chain C₂-C₃₀ alcohols, for example, ethylene glycol; butanediol-, hexanediol-, and octanediolglycidyl ethers; cyclohexane dimethanoldiglycidyl ether, neopentylglycol glycidyl ether, etc.
glycidyl ethers of tri- or polyfunctional, saturated or unsaturated, branched or unbranched, cyclic or open-chain alcohols such as epoxided rhizinusol, epoxided trimethylol propane, epoxided pentaerythrol, or polyglycidyl ethers of aliphatic polyols such as sorbitol, glycerine, trimethylolpropane, etc.
glycidyl ethers of phenol and aniline compounds, such as phenolglycidyl ether, cresolglycidyl ether, p-tert-butylphenol glycidyl ether, nonylphenol glycidyl ether; 3-n-pentadecenylphenol glycidyl ether; 3-n-pentadeca(8,11)dienylphenol glycidyl ether (from cashew nutshell oil); N,N-diglycidyl aniline, etc.
epoxided tertiary amines such as N,N-diglycidyl cyclohexylamine, etc.
epoxided carbonic or carboxylic acids such as neodecanic-acid glycidyl ester, methacrylic-acid glycidyl ester, benzoic-acid glycidyl ester, phthalic-acid tetra- and hexahydrophthalic-acid digly-cidyl ester, diglycidyl esters of dimeric fatty acids, etc.
epoxided di- or trifunctional, low- and high-molecular-weight polyether polyols such as poly-ethyleneglycol diglycidyl ether, polypropylene-glycol diglycidyl ether, etc.

Especially preferred are hexanediol diglycidyl ether, polypropyleneglycol diglycidyl ether, and polyethyleneglycol diglycidyl ether, and 3-n-pentadecenylphenol glycidyl ether, particularly those marketed by Cardolite Europe NV, Belgium, under the trade name of Cardolite® LITE 2513HP or NC-513 (CAS No. 68413-24-1).

Advantageously, the total proportion of epoxide-group-bearing reactive diluents is 1-15% wt., preferably 2-10% wt., relative to the weight of the total composition.

It has been demonstrated that the thermosetting compositions described are usable as single-component construction glues. These glues exhibit an increased impact toughness. In such a method, the surface of these materials is in contact with a composition previously described and includes a curing step.

In embodiments, a method for gluing substrates S1 and S2 includes the steps of:
applying a previously described composition to a substrate S1 and/or a substrate S2,
placing the substrates S1 and S2 in contact by means of the composition applied,
heating the composition to a temperature of 100-200° C., preferably 120-200° C.

The substrates S1 and S2 here may be identical to or different from one another.

It is especially preferred here that at least one of the substrates S1 or S2 be a fibrous material, particularly a carbon-fiber-strengthened material (CFM) or a glass-fiber-strengthened material (GFM), glass, glass-ceramic, a metal, or an alloy.

In particular, it is preferred that at least one substrate S1 or S2 be iron, a light metal, particularly aluminum or magnesium, a non-ferrous metal, or alloys thereof.

In one preferred embodiment, at least one substrate S1 or S2 is a metal or an alloy, which exhibits a coil coating.

In a further preferred embodiment, at least one substrate S1 or S2 is a metal or an alloy whose surface has been modified with a chemical treatment, particularly with a chemical treatment for increasing corrosion resistance. Such a chemical treatment is typically a galvanizing process. A substrate whose surface has been modified with a chemical treatment is understood to be a galvanized substrate. Here galvanizing particularly involves hot-dip galvanizing, electrolytic galvanizing, and the Bonazinc, Galvalume, and Galfan processes, and galvannealing.

Preferred as a substrate whose surface has been modified by a chemical treatment is a hot-dip-galvanized steel, a Bonazinc steel, a Galvalume steel, a Galfan steel, or a galvannealed steel, particularly a hot-dip-galvanized steel, an electrolytically galvanized steel, a Bonazinc steel, or a galvannealed steel. A galvannealed steel is most preferred as a substrate S1 or S2.

Galvannealed steel is a steel produced by a process in which a galvanized steel is annealed after galvanizing in a additional process step to a temperature above the melting point of the zinc.

In particular, defects in the coating structure due to process errors in the manufacture of the coatings result in a reduction in the coating cohesion or adhesion. These defects become evidence during impact stress through increased coating fracture or coating delamination.

It has likewise been demonstrated that such coated or treated metal surfaces often exhibit lower or reduced mechanical strength or reduced adhesion to the metal. It has further been demonstrated that if such substrates are glued with traditional impact-resistant glues, upon the action of a sudden force, the glued bond will fail at relatively low forces, with fracturing occurring within the surface layer or between the surface layer and the metal base.

It is a key property of the composition according to the invention that such a fracture occurs within the glue and the bond consequently is in a layer that can absorb greater forces in the bonded bodies, without the bond being destroyed due to delamination or coating fracture. This is all the more surprising since the mechanical bond properties of the glue, which are not considered in the glued bond, are reduced by using the crack improver C in the composition.

Consequently, the glue, or the bonded bodies glued with it, can absorb greater forces in the layer as compared to known crash-resistant construction glues, without failure of the glued bond. The glues herein are thus also preferred to be “crash-resistant”. Glues are designated as crash-resistant which exhibit a dynamic resistance to cleavage of at least 18 N/mnu, particularly at least 20 N/mm.

A further aspect herein also includes a glued article manufactured by means of one of the gluing methods described above. Since this method is used particularly in industrial manufacture, the glued articles can be finished products incorporated into means of transport, particularly water or land vehicles, preferably an automobile, a bus, a truck, a train, or a ship, or a part thereof.

It is moreover found that the use of a crack improver C results in an increase in the transfer of forces, if it operates with the action of a sudden mechanical force between bonded parts joined by means of a glue, where at least one of these bonded parts is coated with the glue or has been modified by a chemical treatment, and whose coating or near-surface layer exhibits low cohesion or little adhesion to the carrier and where any fracture caused by the action of a sudden mechanical force occurs cohesively in the glue.

This benefit is not only found in thermosetting epoxy-resin compositions, but can also be observed in other glue systems, such as, for example, polyurethane and (meth)acrylate glues. In epoxy-resin glues, especially thermosetting epoxy resin, this effect is consistently observed to date.

### EXAMPLES

The raw materials used in the examples are listed in Table 1.

TABLE 1
Raw Materials Used

| Raw Materials Used | Supplier |
|---|---|
| PolyTHF-1800 (difunctional polybutylene glycol) | BASF |
| (OH-equivalent weight = 900 g/OH-equivalent) | |
| Poly bd ® R45 HTLO (hydroxyl-terminated | Arkema |
| polybutadiene) (OH-equivalent weight = | |
| approx. 1200 g/OH-equivalent) | |
| Alcupol ® D-2021 (difunctional polypropylene glycol) | Repsol |
| (OH-equivalent weight = 1000 g/OH-equivalent) | |
| Isophorone diisocyanate (=IPDI) | Degussa-Hüls |
| Desmophen 3060 BS (trifunctional polypropylene glycol) | Bayer |
| (OH-equivalent weight = 1000 g/OH-equivalent) | |
| Caprolactam | EMS Chemie |
| 4,4′-diphenyl-methylene diisocyanate (=MDI) | Bayer |
| N-butylamine | BASF |
| Bisphenol-A-diglycidylether (=DGEBA) | Huntsman |
| Araldite ® GT 7071 (=GT 7071) | Huntsman |
| Polydis ® 3611 | Struktol |
| Aradur HT 939 EN | Huntsman |
| Dicyandiamide (=Dicy) | Degussa |
| Hexanediol diglycidylether (=HDDGE) | Prümmer |

Sample Production of a Monohydroxyl-Bearing Epoxide (MHE)

Trimethylolpropane glycidylether was produced according to the method in U.S. Pat. No. 5,668,227, Example 1, from trimethylolpropane and epichlorohydrin with tetramethyl ammonium chloride and caustic soda. A yellowish product was obtained with an epoxide number of 7.5 eq/kg and a hydroxyl-group content of 1.8 eq/kg. From the HPLC-MS spectrum, it can be essentially concluded that a mixture of trimethylolpropane diglycidylether and trimethylolpropane triglycidylether was present.

Production of an Example of a Liquid Rubber Exhibiting an Epoxy Group, as an Impact-Toughness Modifier B: Sample B-01

80 g of polyTHF-1800 (OH-number: 62.3 mg/g KOH), 55 g of Poly-bd® R-45HTLO (OH-number: 46.6 mg/g KOH), and 65 g of Alcupol D2021 (OH-number: 56.0 mg/g KOH) were dried for 30 minutes under vacuum at 100° C. Then 46.2 g of IPDI and 0.04 g of dibutyl tin dilaurate were added. The reaction proceeded under vacuum at 90° C. to a constant NCO content of 3.44% after 2.5 hr (theoretical NCO content: 3.6%). Then 117.6 g of the trimethylolpropane glycidylether described above was added as a monohydroxyl-bearing epoxide of formula (III). This was further stirred at 90° C. under vacuum, until the NCO content had decreased to below 0.1% after 3 hr. In this way, a clear product was obtained with an epoxide content (final EP content) of 2.47 eq/kg.

Production of an Example of a Urea Derivative in a Carrier, as an Impact-Toughness Modifier B: Sample B-02

As an example of a urea derivative based on a urea derivative in a non-diffusing carrier, according to EP patent application 1,152,019 A1 in a blocked polyurethane pre-polymer produced with the raw materials mentioned above:

Carrier Material: Blocked Polyurethane Pre-Polymer “BlockPUP”

600.0 g of a polyether polyol (Desmophen 3060BS; 3000 daltons; OH-number: 57 mg/g KOH) were made to react, under vacuum and stirring at 90° C., with 140.0 g of IPDI and 0.10 g of dibutyl tin dilaurate to an isocyanate-terminated pre-polymer. The reaction proceeded to a constant NCO content of 3.41% after 2.5 hours (theoretical NCO content: 3.60%). Then the free isocyanate groups were blocked at 90° C. under vacuum with 69.2 g of caprolactam (2% excess), whereby an NCO content of <0.1% was reached after 3 hr.

Urea Derivative (UD) in a Blocked Polyurethane Pre-Polymer:

Under nitrogen and with slight heat, 68.7 g of MDI flakes were melted in 181.3 g of the blocked “BlockPUP” pre-polymer described above. Then, 40.1 g of N-butylamine, dissolved into 219.9 g of the blocked “BlockPUP” pre-polymer described above, was dripped into the MDI and BlockPUP mixture over the course of two hours under nitrogen and rapid stirring. After the addition of the amine solution was complete, the white Paste was further stirred for another 30 minutes. After cooling, a soft, white Paste was obtained, which exhibited a free isocyanate content of <0.1% (portion of urea derivative approximately 21%).

Production of the Composition:

The reference compositions Ref. 1 and Ref. 2 and the compositions Z1 to Z7 produced according to the invention are presented in Table 2.

Test methods:
Tensile strength (ZF); measured according to ISO 527 at 2 mm/min.
Elongation (BD): measured according to ISO 527, at 2 mm/min.
E-modulus (0.5-1%); measured according to ISO 537, at 2 mm/min.
Fatigue strength (ZSF); (DIN EN 1465)
The test samples were produced from the example compositions described, with an electrolytically galvanized steel (eloZn)(H320) with a size of 100×25 X1.5 mm, in which the glue area was 25×10 mm with a layer thickness of 0.3 mm. These were cured for 30 min at 180° C. The tensile test speed was 10 mm/min.
Dynamic resistance to cleavage (DSW(GA) and dynamic cleavage energy (DSE(GA) (ISO 11343)

The test samples were produced from the compositions described in Table 2 and two galvannealed (GA) steel plates with a size of 90×20×0.8 mm, in which the glue area was 30×20 mm with a layer thickness of 0.3 mm. These were cured for 30 min at 180° C. The impact velocity of the wedge was 2 m/sec. Fracture of the bonded bodies was visually examined after impact stress, and the portion of cohesive fracture in the glue (CF) And delamination of the zinc layer of the base (ZvU) was determined.

TABLE 2
Compositions and Results

| | Ref. 1 | Ref. 2 | Z1 | Z2 | Z3 | Z4 | Z5 | Z6 | Z7 |
|---|---|---|---|---|---|---|---|---|---|
| DGEBA (A) [g] | 12.8 | 13.4 | 12.8 | 13.4 | 13.4 | 13.4 | 13.4 | 13.4 | 13.4 |
| GT 7071 (A) [g] | 19.2 | 20.1 | 19.2 | 20.1 | 20.1 | 20.1 | 20.1 | 20.1 | 20.1 |
| B-01 (B) [g] | 13 | 15 | 13 | 15 | 15 | 15 | 15 | 15 | 15 |
| HSD (B) [g] | 2.34 | 3.41 | 2.34 | 3.41 | 3.41 | 3.41 | 3.41 | 3.41 | 3.41 |
| BlockPUP [g] | 8.66 | 12.59 | 8.66 | 12.59 | 12.59 | 12.59 | 12.59 | 12.59 | 12.59 |
| Polydis ®3611 (B) [g] | | | | | 10 | | | | 10 |
| Talc (C) [g] | | | 10 | 10 | 10 | | | | |
| Mica (C) [g] | | | | | | | | | 10 |
| Graphite (C) [g] | | | | | | 10 | 3 | | |
| Aradur HT939 EN (C) [g] | | | | | | | | 3 | |
| Dicyandiamide (D) [g]] | 3 | 3.3 | 3 | 3.3 | 3.3 | 3.3 | 3.3 | 2.1 | 3.3 |
| HDDGE [g] | 7 | 8 | 7 | 8 | 8 | 8 | 8 | 8 | 8 |
| Filler mixture | 21 | 24 | 11 | 14 | 14 | 14 | 21 | 24 | 14 |
| ZF [MPa] | 32 | 27 | 34 | 26 | 21 | 26 | 22 | 20 | 24 |
| BD [%] | 12 | 12 | 12 | 12 | 10 | 9 | 9 | 16 | 16 |
| E-Modul (0.5-1%) [MPa] | 1169 | 1040 | 1224 | 1000 | 830 | 770 | 880 | 700 | 890 |
| ZSF [MPa] | 29 | 29 | 29 | 24 | 23 | 19 | 24 | 29 | 28 |
| DSW (GA*) [N/mm] | 3.9 | 9.8 | 18.3 | 18.4 | 19.7 | 11.2 | 18.7 | 21.2 | 21.6 |
| DSE (GA*) [J] | 1.3 | 3.9 | 6.4 | 6.7 | 7.8 | 3.3 | 7.5 | 8.4 | 8.3 |
| Fracture (GA*) | | | | | | | | | |
| ZvU** [%] | 100 | 100 | 10 | 1 | 0 | 0 | 0 | 60 | 50 |
| CF*** [%] | 0 | 0 | 90 | 99 | 100 | 100 | 100 | 40 | 50 |

*GA = galvannealed steel,
**ZvU = delamination of zinc layer of base;
***CF = cohesive glue fracture

The results clearly show that the samples Z1 to Z7 exhibit distinctly higher dynamic resistance to cleavage and dynamic cleavage energy compared to the reference samples Ref. 1 and Ref. 2. The results of Table 2 show moreover that by using a crack improver C the glue cracks much more cohesively, especially when graphite or talc is used as the crack improver C.

1. A thermosetting composition comprising
at least one epoxy resin A with an average of more than one epoxide group per molecule;
at least one impact-toughness modifier B;
at least one crack improver C; and
at least one thermally activated epoxy resin hardener D, which is activated by increased temperature.

2. The thermosetting composition according to claim 1, wherein the at least one epoxy resin A is a diglycidyl ether.

3. The thermosetting composition according to claim 1, wherein the impact-toughness modifier B is selected from the group consisting of
rubbers,
core-shell copolymers,
block copolymers, arising from the polymerization of at least two unsaturated monomers, and
urea derivatives in a carrier.

4. The thermosetting composition according to claim 3, wherein the impact-toughness modifier B is a reactive liquid rubber with epoxide groups of formula (II) 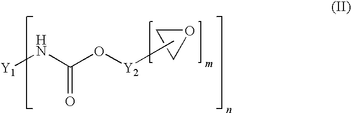
in which
Y₁ represents an n-valent remnant of an isocyanate-terminated, linear or branched polyurethane pre-polymer PU1 after removal of the terminal isocyanate group;
Y₂ represents a remnant of an aliphatic, cycloaliphatic, aromatic, or araliphatic epoxide containing a primary or secondary hydroxyl group, after the removal of the hydroxide and epoxide groups;
m=1, 2, or 3; and
n=2 to 8.

5. The thermosetting composition according to claim 1, wherein the composition contains 5-45% wt. of the impact-toughness modifier B.

6. The thermosetting composition according to claim 1, wherein the crack improver C is a phyllosilicate.

7. The thermosetting composition according to claim 1, wherein the crack improver C is graphite.

8. The thermosetting composition according to claim 1, wherein the crack improver C is a polyamine or polyaminoamide which is solid at room temperature.

9. The thermosetting composition according to claim 1, wherein the composition contains 0.25-25% wt. of the at least one crack improver C.

10. A single-component construction glue comprising the thermosetting composition according to claim 1.

11. A method for gluing heat-resistant materials, the method comprising
joining surfaces of heat-resistant marterials together via the composition according to claim 1, and
curing the composition.

12. A method for gluing substrates S1 and S2, wherein substrates S1 and S2 are the same as, or different from, one another, the method comprising
applying the composition of claim 1 to a substrate S1 and/or a substrate S2,
placing the substrates S1 and S2 in contact through by means of the composition applied, and
heating the composition to a temperature of 100-220° C.

13. The method according to claim 12, wherein at least one of the substrates S1 or S2 is a fibrous material.

14. The method according to claim 12, wherein the at least one substrate S1 or S2 is iron, aluminum, magnesium, a non-ferrous metal, or alloys thereof.

15. The method according to claim 12, wherein at least one substrate S1 or S2 is a metal or an alloy whose surface has been modified by a chemical treatment.

16. The method according to claim 15, wherein the chemical treatment is a galvanizing process.

17. The method according to claim 15, wherein the substrate whose surface has been modified by a chemical treatment is a galvanized substrate.

18. The method according to claim 15, wherein the substrate whose surface has been modified by a chemical treatment is a hot-dip galvanized steel, a Bonazinc steel, a Galvalume steel, a Galfan steel.

19. The method according to claim 12, wherein at least one substrate S1 or S2 is a metal or an alloy with a coil coating.

20. A glued article which is manufactured by means of the method of claim 11.

21. The glued article according to claim 20, wherein the article is a finished product or means of transport.

22. A method for increasing the transfer of forces, by action of a sudden mechanical force between joined pieces bonded together by a glue, comprising
incorporating a crack improver C into a glue, and
utilizing the glue to bond pieces to form the joined pieces, wherein the crack improver C allows for an increase in the transfer of force upon the action of a sudden mechanical force, between the joined pieces bonded to one another by the glue.
